(19) United States
(12) Patent Application Publication
(10) Pub. No.: US 2025/0197215 A1
(43) Pub. Date: Jun. 19, 2025

(54) METHODS FOR RECOVERING HYDROGEN FLUORIDE FROM A FLUOROCARBON PRODUCTION PROCESS

(71) Applicant: Honeywell International Inc., Charlotte, NC (US)

(72) Inventors: Richard D. Horwath, Richmond, VA (US); Gustavo Cerri, Parsippany, NJ (US); Yuon Chiu, Denville, NJ (US); Benson May, Charlotte, NC (US); Jennifer W. McClaine, Branchburg, NJ (US)

(21) Appl. No.: 18/961,134

(22) Filed: Nov. 26, 2024

Related U.S. Application Data
(60) Provisional application No. 63/611,904, filed on Dec. 19, 2023.

(51) Int. Cl. C01B 7/19

(52) U.S. Cl. CPC C01B 7/196; C01B 7/197

(57) ABSTRACT

A method of recovering hydrogen fluoride (HF) in a fluorocarbon production process, including absorbing hydrogen fluoride (HF) from an organic stream into water and distilling the hydrogen fluoride (HF) and water solution to produce a recovered hydrogen fluoride (HF) product. The recovered hydrogen fluoride (HF) product may then be used in a variety of fluorocarbon manufacturing processes.

### CROSS-REFERENCE TO RELATED APPLICATIONS

This application claims the benefit under 35 U.S.C. § 119 (e) of U.S. Provisional Application No. 63/611,904 entitled “METHODS FOR RECOVERING HYDROGEN FLUORIDE FROM A FLUOROCARBON PRODUCTION PROCESS”, filed on Dec. 19, 2023, the entire disclosure of which is incorporated by reference in its entirety.

### FIELD

The present disclosure is directed to methods for recovering hydrogen fluoride (HF) from a product mixture produced by a fluorocarbon manufacturing process.

### BACKGROUND

Fluorocarbons, and specifically hydrofluoroolefins (HFOs) have gained attention as alternatives to traditional hydrofluorocarbons (HFCs) in a variety of applications. The shift towards HFOs is primarily driven by environmental concerns and the need to address the detrimental effects of global warming.

The synthesis of fluorocarbons typically involves the manipulation of hydrocarbons through halogen addition and/or removal processes. Some methods involve the direct fluorination of hydrocarbons, where hydrogen atoms are replaced with elemental fluorine. Another method involves the use of chlorofluorocarbons or hydrochlorofluorocarbons as starting materials. These compounds are partially fluorinated and can undergo further halogen addition and/or removal reactions to produce fluorinated compounds.

The halogen addition and/or removal reactions in these methods produce other minor byproducts such as hydrogen fluoride (HF) which need to be separated and recovered from the organic products. The hydrogen fluoride (HF) generated in these processes may be separated and then neutralized using a base such as calcium hydroxide (Ca(OH)₂), for example, followed by disposal. Also, separation methods have limitations as they yield relatively impure hydrogen fluoride (HF) solution with small amounts of organic contaminants, restricting viability for commercial applications.

As a result, the majority of the hydrogen fluoride (HF) solution must be neutralized and discarded as waste.

### SUMMARY

In the present process for recovering hydrogen fluoride (HF) produced in a fluorocarbon manufacturing processes, such as a process for manufacturing trans-1,3,3,3-tetrafluoropropene (HFO-1234ze (E)), hydrogen fluoride (HF) can be captured by absorption in water to form a solution having a weight percent of hydrogen fluoride (HF) which is advantageously above the azeotropic ratio of hydrogen fluoride (HF) to water. The water/hydrogen fluoride (HF) solution may itself be subjected to further separation processes, such as distillation to facilitate the recovery of more purified hydrogen fluoride (HF) that may be commercially sold and/or used as a chemical input in a variety of additional continuous fluorocarbon manufacturing processes, such as a process for manufacturing 2,3,3,3-tetrafluoropropene (HFO-1234yf) and/or a process for manufacturing trans-1-chloro-3,3,3-trifluoropropene (HFO-1233zd (E)).

The most prevalent manufacturing process for anhydrous hydrogen fluoride (HF) in current practice is an energy intensive process using CaF₂ and H₂SO₄ as raw materials. As opposed to the current process, the present process of recovering HF from fluorocarbon manufacturing processes advantageously avoids the significant carbon footprint that results from producing HF via the use of CaF₂ and H₂SO₄. Additionally, recovery of HF according to the present process avoids CO₂ emissions related to the production of Ca(OH)₂, which is typically used to neutralize the HF.

In one form thereof, the present disclosure provides a method of recovering hydrogen fluoride (HF) in a fluorocarbon production process, comprising: absorbing hydrogen fluoride (HF) from an organic stream into water in an absorption column to form a first solution of hydrogen fluoride (HF) and water having greater than about 35 wt. % HF; conveying at least a portion of the first solution of hydrogen fluoride (HF) and water to a distillation column; and distilling the first solution of hydrogen fluoride (HF) and water to provide a first distillate comprising at least about 95 wt. % hydrogen fluoride (HF) and a first bottoms stream comprising a second solution of hydrogen fluoride (HF) and water having greater than about 35 wt. % HF.

In another form thereof, the present disclosure provides a method of recovering hydrogen fluoride (HF) in a fluorocarbon production process, comprising: absorbing hydrogen fluoride (HF) from an organic stream into water in an absorption column to form a first solution of hydrogen fluoride (HF) and water having greater than about 35 wt. % HF; conveying at least a portion of the first solution of hydrogen fluoride (HF) and water to a distillation column; distilling the first solution of hydrogen fluoride (HF) and water to provide a first distillate comprising at least about 70 wt. % hydrogen fluoride (HF) and a first bottoms stream comprising a second solution of hydrogen fluoride (HF) and water having greater than about 35 wt. % HF; and distilling the first distillate to provide a second distillate comprising at least about 95 wt. % hydrogen fluoride (HF) and a second bottoms stream.

In a further form thereof, the present disclosure provides A hydrogen fluoride composition, comprising: at least 95 wt. % hydrogen fluoride; from 0.0001 wt. % to 0.8 wt. % 1,1,1,3,3-pentafluoropropane (HFC-245fa); from 0.0001 wt. % to 0.2 wt. % cis-1,3,3,3-tetrafluoropropene (HFO-1234ze (Z)); from 0.0001 wt. % to 0.1 wt. % trans-1,3,3,3-tetrafluoropropene (HFO-1234ze (E)); from 0.0001 wt. % to 0.01 wt. % trans-1-chloro-3,3,3-trifluoropropene (HFO-1233zd (E)); and less than 0.06 wt. % other fluorinated products.

### BRIEF DESCRIPTION OF THE DRAWINGS

FIG. 1 is a process diagram for the hydrogen fluoride (HF) recovery process described in Examples 1-3.

### DETAILED DESCRIPTION

### I. Definitions

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range.

As used herein, the phrase “within any range encompassing any two of these values as endpoints” or “any range using any two of the foregoing values as endpoints” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### II. Methods for Recovering Hydrogen Fluoride (HF) from a Fluorocarbon Production Process

The present disclosure provides methods for recovering hydrogen fluoride in a fluorocarbon production process, for example, a process for the production of trans-1,3,3,3-tetrafluoropropene (HFO-1234ze (E)).

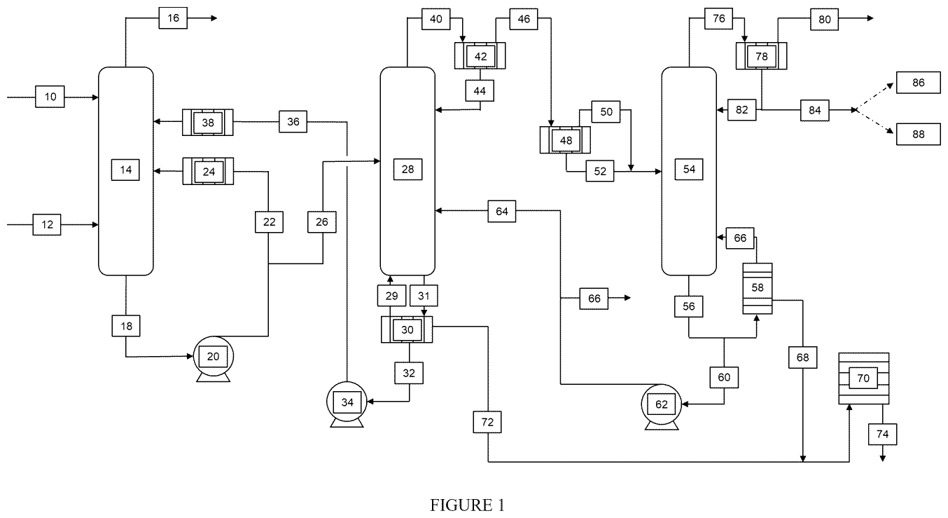

An exemplary embodiment of the present method is shown in the process diagram of FIG. 1. In the first step, organic stream 12 and water stream 10 are fed into absorption column 14. The organic stream may be the product stream from any fluorocarbon production process, such as, for example, a process for producing trans-1,3,3,3-tetrafluoropropene (HFO-1234ze (E)).

Organic stream 12 may be in the gas phase and may comprise a mixture of different organic compounds, including hydrogen fluoride (HF), trans-1,3,3,3-tetrafluoropropene (HFO-1234ze (E)), cis-1,3,3,3-tetrafluoropropene (HFO-1234ze (Z)), and/or 1,1,1,3,3-pentafluoropropane (HFC-245fa).

The amount of hydrogen fluoride (HF) in the organic stream 12 may be as low as about 1 wt. %, about 2 wt. %, about 3 wt. %, about 4 wt. %, about 5 wt. %, about 6 wt. %, about 7 wt. %, about 8 wt. %, about 9 wt. %, or as high as about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, or within any range encompassed by any two of the foregoing values as endpoints, such as from about 1 wt. % to about 20 wt. %, from about 3 wt. % to about 18 wt. %, and about 8 wt. % to about 12 wt. %, based upon the total weight of the contents of organic stream 12.

The amount of trans-1,3,3,3-tetrafluoropropene (HFO-1234ze (E)) in organic stream 12 may be as low as about 20 wt. %, about 25 wt. %, about 30 wt. %, about 35 wt. %, about 40 wt. %, about 45 wt. %, or as high as about 50 wt. %, about 55 wt. %, about 60 wt. %, or within any range encompassed by any two of the foregoing values as endpoints, such as from about 20 wt. % to about 60 wt. %, from about 25 wt. % to about 55 wt. %, and about 40 wt. % to about 50 wt. %, based upon the total weight of the contents of organic stream 12.

The amount of cis-1,3,3,3-tetrafluoropropene (HFO-1234ze (Z)) may be as low as about 0 wt. %, about 5 wt. %, 10 wt. %, or as high as about 15 wt. %, about 20 wt. %, or within any range encompassed by any two of the foregoing values, such as from about 0 wt. % to about 20 wt. %, or from about 5 wt. % to about 15 wt. % based upon the total weight of the contents of organic stream 12.

The amount of 1,1,1,3,3-pentafluoropropane (HFC-245fa) in organic stream 12 may be as low as about 20 wt. %, about 25 wt. %, about 30 wt. %, about 35 wt. %, or as high as about 40 wt. %, about 45 wt. %, about 50 wt. %, about 55 wt. %, about 60 wt. %, or within any range encompassed by any two of the foregoing values as endpoints, such as from about 20 wt. % to about 60 wt. %, from about 25 wt. % to about 55 wt. %, and about 40 wt. % to about 50 wt. %, based upon the total weight of the contents of organic stream 12.

As discussed further below, absorption column 14 is also fed by stream 36 which passes through cooler 38 before entering the absorption column. Stream 36 is cooled because the top of column 14 ideally operates at a temperature low enough to avoid carryover of hydrogen fluoride (HF) with the other organics in stream 16. Carryover of hydrogen fluoride (HF) in this stream would reduce the amount of recovered hydrogen fluoride (HF) in the product stream 84.

Preferably, stream 36 is cooled to a temperature low enough to reduce the level of hydrogen fluoride (HF) but high enough to avoid condensing the organics into the hydrogen fluoride (HF) solution. Before entering cooler 38, stream 36 may be at a temperature of from 100° C. to 150° C. Upon exiting from cooler 38, stream 36 may be at a temperature of from 0° C. to 50° C.

Stream 36 comprises a mixture of water and HF. Preferably, the concentration of hydrogen fluoride in stream 36 is kept above the water/hydrogen fluoride (HF) azeotrope which exists at about 35.35 wt. % HF at atmospheric pressure, based upon the total weight of the components in stream 36.

The amount of hydrogen fluoride (HF) in stream 36 may about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, or within any range encompassed by any two of the foregoing values as endpoints, such as from about 36 wt. % to about 60 wt. %, from about 38 wt. % to about 55 wt. %, from about 40 wt. % to about 50 wt. %, and about 43 wt. % to about 47 wt. %.

Inside absorption column 14, hydrogen fluoride (HF) is absorbed into the liquid HF/water solution, thus increasing the concentration of hydrogen fluoride (HF) in the water solution and decreasing the concentration of hydrogen fluoride (HF) in the organic stream. The organic products with a reduced amount of hydrogen fluoride (HF) exit the absorption column 14 through product stream 16. Preferably, the top of column 14 is maintained at an operating temperature of from 0° C. to 50° C.

The amount of hydrogen fluoride (HF) in product stream 16, if present, may be as low as about 10 ppm, about 100 ppm, about 200 ppm, about 300 ppm, about 400 ppm, about 500 ppm, about 600 ppm, about 700 ppm, about 800 ppm, about 900 ppm, about 1000 ppm, about 2000 ppm, about 3000 ppm, about 4000 ppm, about 5000 ppm or as high as about 6000 ppm, about 8000 ppm, about 9000 ppm, about 10,000 ppm, or within any range encompassed by any two of the foregoing values as endpoints, such as from about 10 ppm to about 10,000 ppm, from about 200 ppm to about 8000 ppm, from about 500 ppm to about 5000 ppm, and from about 1000 ppm to about 3000 ppm.

The purified product stream 16 may be further processed to recover desired products such as trans-1,3,3,3-tetrafluoropropene (HFO-1234ze (E)) and/or recycled back into a fluorocarbon manufacturing process.

The HF/water solution with an increased concentration of hydrogen fluoride (HF) exits absorption column 14 through bottoms stream 18 and may be conveyed via pump 20, for example, to the next steps of the process. The contents of bottoms stream 18 as they exit from the distillation column may be at as low as about 25° C., about 30° C., about 35° C., about 40° C., about 45° C., about 50° C., or as high as about 55° C., about 60° C., about 65° C., about 70° C., about 75° C., about 80° C., about 85° C., about 90° C., about 95° C., about 100° C., or within any range encompassed by any two of the foregoing values as endpoints, such as from about 25° C. to about 100° C., from about 30° C. to about 90° C., from about 40° C. to about 80° C., and from about 50° C. to about 60° C.

From pump 20, the bottoms stream 18 gets split into recycle stream 22, which passes through cooler 24 before returning to absorption column 14, and intermediate stream 26 which is sent to distillation column 28.

Recycle stream 22 may comprise hydrogen fluoride (HF) in an amount from about 30 wt. %, about 35 wt. %, about 35.35 wt. %, about 40 wt. %, about 45 wt. % about 50 wt. %, about 51 wt. %, about 52 wt. % to about 53 wt. %, about 54 wt. %, about 55 wt. %, about 56 wt. %, about 57 wt. %, about 58 wt. %, about 59 wt. %, about 60 wt. %, or within any range encompassed by any two of the foregoing ranges as endpoints, such as from about 30 wt. % to about 60 wt. %, from about 40 wt. % to about 55 wt. %, and from about 45 wt. % to about 50 wt. %, based upon a total weight of HF and H₂O in stream 22.

Recycle stream 22 may be cooled to a temperature of less than about 100° C., less than about 90° C., less than about 80° C., less than about 70° C., less than about 60° C., less than about 50° C., less than about 40° C., less than about 30° C. less than about 25° C., less than about 20° C., less than about 15° C., or within any range encompassed by any two of the foregoing values as endpoints, such as from about 15° C. to about 100° C., from about 20° C. to about 90° C., from about 30° C. to about 80° C., and from about 50° C. to about 70° C., before it enters absorption column 14.

Cooling recycle stream 22 to a lower temperature allows it to absorb heat produced by the dissolution of hydrogen fluoride (HF) into the water solution in the absorption column. In general, maintaining the temperature of absorption column 14 and its contents at below about 10° C. maximizes the hydrogen fluoride (HF) concentration in the aqueous solution inside the absorption column. A high hydrogen fluoride (HF) concentration in the aqueous solution is desirable because it makes the subsequent distillation step more efficient.

The contents of intermediate stream 26 may be distilled once or multiple times to increase the hydrogen fluoride (HF) concentration. Referring to FIG. 1, the distillation portion of the process diagram involves a two-step distillation with two separate distillation columns: distillation column 28 and distillation column 54. The distillation columns(s) may be fed by two or more streams of hydrogen fluoride (HF) solution from different sources such as multiple fluorocarbon manufacturing processes.

Distillation column 28 is fed by intermediate stream 26 which comprises a water/hydrogen fluoride (HF) solution. Intermediate stream 26 may comprise hydrogen fluoride (HF) in an amount as low as about 30 wt. %, about 35 wt. %, about 35.35 wt. %, about 40 wt. %, about 45 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, or within any range encompassed by any two of the foregoing ranges as endpoints, such as from about 30 wt. % to about 60 wt. %, from about 40 wt. % to about 55 wt. %, and from about 45 wt. % to about 50 wt. %, based upon a total weight of recycle stream 22.

In general, it is preferred for the concentration of hydrogen fluoride (HF) in stream 26 to be relatively high for better distillation efficiency and lower utility consumption (i.e., heating and cooling duties) in distillation column 28.

Distillation columns 28 and 54 may both be operated at the same temperature and pressure conditions. The temperature may be as low as about 10° C., about 20° C., about 30° C., about 40° C., about 50° C., about 60° C., about 70° C., about 80° C., about 90° C., about 100° C., as high as about 110° C., about 120° C., about 130° C., about 140° C., about 150° C., about 160° C., about 170° C., or within any range encompassed by any two of the foregoing values as endpoints, such as from about 10° C. to about 170° C., from about 20° C. to about 160° C., from about 40° C. to about 140° C., from about 60° C. to about 120° C., and from about 80° C. to about 100° C.

The pressure in each column may be as low as about 5 psia, about 10 psia, about 15 psia, about 20 psia, about 25 psia, about 30 psia, about 35 psia, about 40 psia, about 45 psia, about 50 psia, or as high as about 60 psia, about 64.7 psia, about 65 psia, about 70 psia, or within any range encompassed by any two of the foregoing values as endpoints, such as from about 15 psia to about 70 psia, from about 20 psia to about 65 psia, from about 30 psia to about 60 psia, and from about 40 psia to about 50 psia.

Referring again to FIG. 1, top stream 40 exits the top of distillation column 28 and comprises at least about 60 wt. %, at least about 65 wt. %, at least about 70 wt. %, at least about 75 wt. %, at least about 80 wt. %, at least about 85 wt. %, at least about 90 wt. %, at least about 95 wt. %, at least about 97 wt. %, or at least about 99 wt. % HF, or any range using any two of the foregoing values as endpoints, such as from about 60 wt. % to about 99 wt. %, from about 65 wt. % to about 95 wt. %, and about 70 wt. % to about 80 wt. %, based on a total weight of stream 40. Top stream 40 is cooled and condensed partially or totally in cooler 42 and then splits into recycle stream 44, which is fed back into distillation column 28, and intermediate stream 46 which is fed into optional cooler 48. From cooler 48, intermediate streams 50 and 52 exit and are both conveyed to second distillation column 54. The contents of stream 50 may primarily be in the vapor phase while stream 52's contents may be in the liquid phase.

Partially condensing or cooling these streams before they enter distillation column 54 helps to reduce the vapor load in the column. The bottoms stream 31 from distillation column 28 exits and enters heater 30. From heater 30, the bottoms stream splits into recycle stream 29, which returns to the distillation column 28, recycle stream 32, which is conveyed to pump 34, and intermediate stream 72, which proceeds to cooler 70. Heater 30 can be any type of heat exchanger in reboiler service such as a kettle vaporizer or vertical thermosiphon. Pump 34 conveys stream 36, through cooler 38 and back into absorption column 14. Stream 72, which comprises mostly water passes through cooler 70 and is discarded to sewer via waste stream 74.

Stream 36 may comprise hydrogen fluoride (HF) in an amount above the HF/water azeotrope range. Avoiding the HF/water azeotrope in stream 36 promotes a more effective purification of hydrogen fluoride (HF) and improves the efficiency of the distillation steps. The amount of hydrogen fluoride (HF) in stream 36 may be greater than 40 wt. %, greater than about 45 wt. %, greater than about 50 wt. %, greater than about 55 wt. %, greater than about 60 wt. %, or within any range defined by any two of the foregoing values as endpoints, such as from about 40 wt. % to about 60 wt. %, from about 45 wt. % to about 55 wt. %, and about 50 wt. % to about 55 wt. %, based on the total HF and H2O of stream 36.

The second distillation column 54 is fed by inlet stream 52 which may comprise at least about 90 wt. % HF for example, at least about 92 wt. % HF, about 95 wt. % HF, about 97 wt. % HF, 98 wt. % HF, or about 99 wt. % HF, or any range using any two of the foregoing values as endpoints, such as from about 90 wt. % to about 99 wt. %, from about 92 wt. % to about 98 wt. %, or about 95 wt. % to about 97 wt. %, based on a total weight of inlet stream 52. Top stream 76 exits the top of distillation column 54 and comprises at least 90 wt. % HF, based on a total HF and H2O of stream 76.

Steam 76 is then cooled and condensed partially or totally in cooler 78 and splits into three separate streams, including recycle stream 82 which is fed back into distillation column 54, waste stream 80 which is either further processed for recovery of usable byproducts or purged from the system, and hydrogen fluoride (HF) product stream 84 which is sent to storage.

The composition of the final hydrogen fluoride (HF) product in stream 84 may comprise minimal amounts of organic impurities. Product stream 84 may comprise trans-1,3,3,3-tetrafluoropropene (HFO-1234ze (E)), 1,1,1,3,3-pentafluoropropane (HFC-245fa), cis-1,3,3,3-tetrafluoropropene (HFO-1234ze (Z)), trans-1-chloro-3-3-3-trifluoropropene (HFO-1233zd (E)), 1,1,2-trichloro-1,2,2-trifluoroethane (CFC-113), 1,2-dichlorotetrafluoroethane (CFC-114) and 2-chloro-3,3,3-trifluoroprop-1-ene (HCFO-1233xf).

Product stream 84 may comprise trans-1,3,3,3-tetrafluoropropene (HFO-1234ze (E)) in an amount as low as about 1 ppm, about 10 ppm, about 30 ppm, about 50 ppm, about 70 ppm, about 100 ppm, about 200 ppm, about 300 ppm, about 400 ppm, about 500 ppm, or as high as about 600 ppm, about 700 ppm, about 800 ppm, about 900 ppm, about 1000 ppm, or within any range encompassed by any two of the foregoing ranges as endpoints, such as from about 1 ppm to about 1000 ppm, from about 10 ppm to about 800 ppm, from about 50 ppm to about 700 ppm, and from about 100 ppm to about 600 ppm.

Alternatively stated, product stream 84 may comprise trans-1,3,3,3-tetrafluoropropene (HFO-1234ze (E)) in an amount, if present, less than about 0.0001 wt. %, about 0.0005 wt. %, about 0.001 wt. %, about 0.005 wt. %, about 0.01 wt. %, about 0.05 wt. %, and for each of the foregoing, greater than 0 wt. %, or within any range encompassed by any two of the foregoing values as endpoints, such as from about 0 wt. % to about 0.05 wt. %, from about 0.0001 wt. % to about 0.01 wt. %, and from about 0.0005 wt. % to about 0.005 wt. %, based upon the total weight of the contents of product stream 84.

Product stream 84 may comprise 1,1,1,3,3-pentafluoropropane (HFC-245fa) in an amount as low as about 1 ppm, about 50 ppm, about 100 ppm, about 200 ppm, about 300 ppm, about 400 ppm, about 500 ppm, about 600 ppm, about 700 ppm, about 800 ppm, about 900 ppm, about 1000, or as high as about 1500 ppm, about 2000 ppm, about 2500 ppm, about 3000 ppm, about 3500 ppm, about 4000 ppm, about 4500 ppm, about 5000 ppm, about 5500 ppm, about 6000 ppm, about 6500 ppm, about 7000 ppm, about 7500 ppm, about 8000 ppm, or within any range encompassed by any two of the foregoing values as endpoints, such as from about 1 ppm to about 8000 ppm, from about 50 ppm to about 7000 ppm, from about 100 ppm to about 6000 ppm, from about 500 ppm to about 5000 ppm, and from about 1000 ppm to about 2500 ppm.

Alternatively stated, product stream 84 may comprise 1,1,1,3,3-pentafluoropropane (HFC-245fa) in an amount, if present, as low as about 0.0001 wt. %, about 0.0002 wt. %, about 0.0003 wt. %, about 0.0004 wt. %, about 0.0005 wt. %, about 0.0006 wt. %, about 0.0007 wt. %, about 0.0008 wt. %, about 0.0009 wt. %, about 0.001 wt. %, about 0.0011 wt. %, or as high as about 0.0012 wt. %, about 0.0013 wt. %, about 0.0014 wt. %, about 0.0015 wt. %, about 0.0016 wt. %, about 0.0017 wt. %, about 0.0018 wt. %, about 0.0019 wt. %, about 0.002 wt. %, about 0.0021 wt. %, about 0.0022 wt. %, about 0.0023 wt. %, about 0.0024 wt. %, about 0.0025 wt. %, about 0.0026 wt. %, or within any range encompassed by any two of the foregoing values as endpoints, such as from about 0 wt. % to about 0.0026 wt. %, from about 0.0018 wt. % to about 0.0025 wt. %, and from about 0.0019 wt. % to about 0.0023 wt. %, based upon the total weight of product stream 84.

Product stream 84 may comprise cis-1,3,3,3-tetrafluoropropene (HFO-1234ze (Z)) in an amount, if present, as low as 1 ppm, 25 ppm, 50 ppm, 75 ppm, 100 ppm, 150 ppm, 200 ppm, 250 ppm, 300 ppm, about 350 ppm, about 400 ppm, about 500 ppm, about 700 ppm, or as high as about 1000 ppm, about 1200 ppm, about 1500 ppm, about 1800 ppm, about 2000 ppm, or within any range encompassed by any two of the foregoing values as endpoints, such as from about 1 ppm to about 2000 ppm, from about 100 ppm to about 1500 ppm, and from about 500 ppm to about 1200 ppm.

Alternatively stated, product stream 84 may comprise cis-1,3,3,3-tetrafluoropropene (HFO-1234ze (Z)) in an amount, if present, as low as about 0.001 wt. %, about 0.002 wt. %, about 0.003 wt. %, about 0.004 wt. %, about 0.005 wt. %, about 0.006 wt. %, about 0.007 wt. %, about 0.008 wt. %, about 0.009 wt. %, about 0.01 wt. %, or as high as about 0.011 wt. %, about 0.012 wt. %, about 0.013 wt. %, about 0.014 wt. %, about 0.015 wt. %, about 0.016 wt. %, about 0.017 wt. %, about 0.018 wt. %, or within any range encompassed by any two of the foregoing values as endpoints, such as from about 0.001 wt. % to about 0.018 wt. %, from about 0.003 wt. % to about 0.0016 wt. %, from about 0.005 wt. % to about 0.015 wt. %, and from about 0.008 wt. % to about 0.011 wt. %, based upon the total weight of product stream 84.

Product stream 84 may comprise trans-1-chloro-3-3-3-trifluoropropene (HFO-1233zd (E)) in an amount, if present, as low as about 30 ppm, about 40 ppm, about 50 ppm, about 60 ppm, or as high as about 70 ppm, about 80 ppm, about 90 ppm, about 100 ppm, or within any range encompassed by any two of the foregoing values as endpoints, such as from about 30 ppm to about 100 ppm, from about 40 ppm to about 90 ppm, from about 50 ppm to about 80 ppm, and from about 60 ppm to about 70 ppm.

Product stream 84 may comprise 1,1,2-trichloro-1,2,2-trifluoroethane (CFC-113), 1,2-dichlorotetrafluoroethane (CFC-114), and 2-chloro-3,3,3-trifluoroprop-1-ene (HCFO-1233xf) in a total amount, if present, as low as about 400 ppm, about 500 ppm, about 600 ppm, or as high as about 700 ppm, about 800 ppm, or within any range encompassed by any two of the foregoing values as endpoints, such as from about 400 ppm to about 800 ppm, from about 500 ppm to about 700 ppm, and about 600 ppm to about 700 ppm.

Alternatively, product stream 84 may comprise 1,1,2-trichloro-1,2,2-trifluoroethane (CFC-113), 1,2-dichlorotetrafluoroethane (CFC-114), and 2-chloro-3,3,3-trifluoroprop-1-ene (HCFO-1233xf) in a total amount as low as about 0.04 wt. %, about 0.05 wt. %, about 0.06 wt. %, or as high as about 0.07 wt. %, about 0.08 wt. %, or within any range encompassed by any two of the foregoing values as endpoints, such as from about 0.04 wt. % to about 0.08 wt. %, from about 0.05 wt. % to about 0.07 wt. %, and from about 0.06 wt. % to about 0.07 wt. %, based upon the total weight of product stream 84.

Product stream 84 comprising pure and anhydrous hydrogen fluoride (HF) may itself be commercially sold and/or may conveyed directly into another chemical manufacturing process as a starting material. For example, product stream 84 may be used for fluorination reactions in a process to manufacture 2,3,3,3-tetrafluoropropene (HFO-1234yf), labeled 86 in FIG. 1, or a process to manufacture trans-1-chloro-3-3-3-trifluoropropene (HFO-1233zd (E)), labeled 88.

The bottoms stream 56 exits from distillation column 54 and enters heater 58. Recycle stream 60 splits from bottoms stream 56 and is conveyed through pump 62. From pump 62, stream 64 enters back into distillation column 28 and purge stream 66 is conveyed to waste. Purge stream 66 may be used to control impurities that build up as high-boiling components in the distillation system.

Purge stream 66 may be further processed to recover usable products or neutralized and disposed of. Purge stream 66 may comprise hydrogen fluoride (HF) in an amount as low as about 50 wt. %, about 55 wt. %, about 60 wt. %, about 65 wt. %, or as high as about 70 wt. %, about 75 wt. %, about 80 wt. %, about 85 wt. %, about 90 wt. %, about 95 wt. %, or within any range encompassed by any two of the foregoing value as endpoints, such as from about 50 wt. % to about 95 wt. %, from about 55 wt. % to about 85 wt. %, from about 60 wt. % to about 80 wt. %, and from about 65 wt. % to about 70 wt. %, based on the total weight of purge stream 66. From heater 58, a recycle stream 66 is conveyed back into distillation column 54 and a waste stream 68 joins with waste stream 72 and is conveyed towards cooler 70. Heater 58 can be any type of heat exchanger in reboiler service such as a kettle vaporizer or vertical thermosiphon. From cooler 70, waste stream 74 exits the system and is conveyed to the sewer.

As discussed above, product stream 84, comprising anhydrous HF, may be fed directly from the instant process into another chemical manufacturing process which utilizes hydrogen fluoride (HF) as a reactant. For example, the anhydrous hydrogen fluoride (HF) stream may be used in a process for manufacturing 2,3,3,3-tetrafluoropropene (HFO-1234yf). The manufacture of 2,3,3,3-tetrafluoropropene (HFO-1234yf) from 1,1,2,3-tetrachloropropene (HCO-1230xa) and hydrogen fluoride can be generalized in a three-step process. In both steps 1, and 2, hydrogen fluoride from the instant process may be used as a reactant. Step 1 can be understood as producing 2-chloro-3,3,3-trifluoropropene (HCFO-1233xf) from 1,1,2,3-tetrachloropropene (HCO-1230xa) in a vapor phase reactor according to the following reaction scheme:

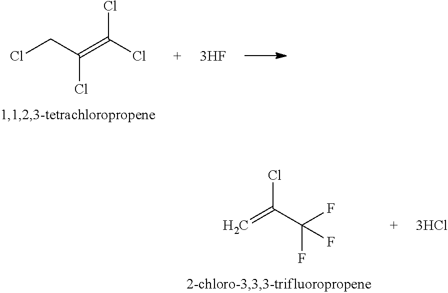

Step 2 can be understood as producing 2-chloro-1,1,1,2-tetrafluoropropane (HFCF-244bb) from 2-chloro-3,3,3-trifluoropropene (HCFO-1233xf) in a reactor, such as a liquid phase reactor, according to the following reaction scheme:

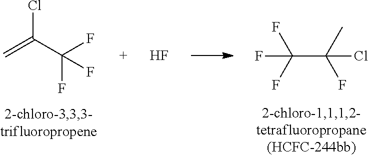

Step 3 can be understood as a dehydrochlorination reaction producing 2,3,3,3-tetrafluoropropene (HFO-1234yf) from 2-chloro-1,1,1,2-tetrafluoropropane (HCFC-244bb) in a reactor, such as a vapor phase reactor, according to the following reaction scheme:

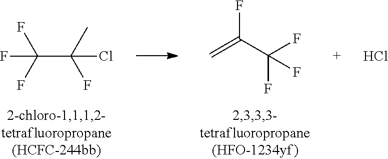

In another embodiment, product stream 84, comprising anhydrous HF, may be fed directly into a process for manufacturing 1-chloro-3,3,3-trifluoropropene (HCFO-1233zd), particularly trans-1-chloro-3,3,3-trifluoropropene (HCFO-1233zd (E)). trans-1-Chloro-3,3,3-trifluoropropene (HCFO-1233zd (E)) may be manufactured via the fluorination of 1,1,1,3,3-pentachloropropane (HCC-240fa) using hydrogen fluoride.

The overall chemical equation for the non-catalytic reaction of HCC-240fa and hydrogen fluoride (HF) to form 1-chloro-3,3,3-trifluoropropene (HCFO-1233zd) is set forth below as Equation (I):

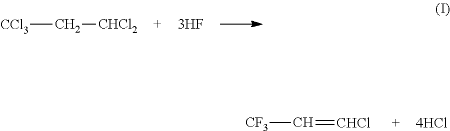

Typically, the foregoing reaction is performed without a catalyst in an agitated liquid phase reactor at a reaction temperature of 120-140° C. and a reaction pressure of 230-400 psig.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

### EXAMPLES

### Example 1: Conditions and Operations in Column T-1

Referring to the process diagram shown in FIG. 1, absorption column 14 is fed by water stream 10 and organic stream 12 which comprises a gas phase mixture of hydrogen fluoride (HF), trans-1,3,3,3-tetrafluoropropene (HFO-1234ze (E)), cis-1,3,3,3-tetrafluoropropene (HFO-1234ze (Z)), and/or 1,1,1,3,3-pentafluoropropane (HFC-245fa). The amount of hydrogen fluoride (HF) in organic stream 12 is about 10 wt. %, based upon the total weight of the components in stream 12. Absorption column 14 is also fed by stream 36 which contains a mixture of about 60 wt. % water and about 40 wt. % hydrogen fluoride (HF) at about 25° C.

The temperature of absorption column 14 is maintained at about 25° C. Inside the column, hydrogen fluoride (HF) is absorbed into the liquid solution of water and hydrogen fluoride (HF). The organic products with 5,000 ppm of hydrogen fluoride (HF) exit the absorption column 14 in product stream 16.

The solution of water and hydrogen fluoride (HF) with an increased concentration of hydrogen fluoride (HF) exits absorption column 14 through bottoms stream 18 and is conveyed via pump 20 to the next steps of the process, such as intermediate stream 26 and distillation column 28 discussed in Example 2 below.

### Example 2: Conditions and Operations in Column T-2

From bottoms stream 18 created in Example 1, pump 20 conveys stream 18 into intermediate stream 26. Distillation column 28 is fed by intermediate stream 26 which contains a solution of about 50 wt. % water and about 50 wt. % hydrogen fluoride (HF). Distillation column 28 is operated at a temperature of about 100° C. and a pressure of about 15 psia. Top stream 40 exits the distillation column 28 and includes about 75 wt. % HF, based upon a total weight of top stream 40. Top steam 40 is then cooled and condensed partially in cooler 42 and then split into recycle stream 44, which is fed back into distillation column 28, and intermediate stream 46 which is fed into cooler 48. From cooler 48, intermediate streams 50 and 52 exit and are both conveyed to second distillation column 54, discussed in Example 3 below.

The bottoms stream 31 from distillation column 28 exits and enters heater 30 and is warmed to a temperature of about 11° C. From heater 30, the bottoms stream splits into recycle stream 29, which returns to the distillation column 28, recycle stream 32, which is conveyed to pump 34. Pump 34 conveys stream 36, through cooler 38 and back into absorption column 14.

### Example 3: Conditions and Operations in Column T-3

Referring again to the process diagram shown in FIG. 1, the second distillation column 54 is fed by inlet streams 50 and 52 which includes about 75 wt. % HF and about 25 wt. % water, based upon the total weight of the contents of inlet stream 52. Distillation column 28 is operated at a temperature of about 20° C. and a pressure of about 15 psia. Top stream 76 exits from the top of distillation column 54 and is then cooled and condensed partially in cooler 78 and split into three separate streams, including recycle stream 82 which is fed back into distillation column 54, waste stream 80 which is purged from the system, and hydrogen fluoride (HF) product stream 84 which is sent to storage. Product stream 84 contains about 100 ppm of trans-1,3,3,3-tetrafluoropropene (HFO-1234ze (E)), about 1500 ppm of 1,1,1,3,3-pentafluoropropane (HFC-245fa), about 350 ppm of cis-1,3,3,3-tetrafluoropropene (HFO-1234ze (Z)), about 30 ppm of trans-1-chloro-3-3-3-trifluoropropene (HFO-1233zd (E)) and 1,1,2-trichloro-1,2,2-trifluoroethane (CFC-113), 1,2-dichlorotetrafluoroethane (CFC-114), and 2-chloro-3,3,3-trifluoroprop-1-ene (HCFO-1233xf) in a total amount of about 400 ppm.

The bottoms stream 56 exits from distillation column 54 and enters heater 58 where it is heated to a temperature of about 30° C. . . . Recycle stream 60 splits from bottoms stream 56 and is conveyed through pump 62. From pump 62, stream 64 enters back into distillation column 28 and purge stream 66, containing about 65 wt. % HF, is conveyed to waste.

### Example 4: Anhydrous Hydrogen Fluoride (HF) Product Per Se Composition

The anhydrous hydrogen fluoride (HF) product exiting column has the following composition: 500 ppm of trans-1,3,3,3-tetrafluoropropene (HFO-1234ze (E)), 4000 ppm of 1,1,1,3,3-pentafluoropropane (HFC-245fa), 1000 ppm of cis-1,3,3,3-tetrafluoropropene (HFO-1234ze (Z)), 1100 ppm of trans-1-chloro-3-3-3-trifluoropropene (HFO-1233zd (E)), and a combined total 600 ppm of 1,1,2-trichloro-1,2,2-trifluoroethane (CFC-113), 1,2-dichlorotetrafluoroethane (CFC-114), and 2-chloro-3,3,3-trifluoroprop-1-ene (HCFO-1233xf).

### Example 5: Production of 2,3,3,3-Tetrafluoropropene (HFO-1234yf)

The anhydrous hydrogen fluoride (HF) product of Example 4 is conveyed to a manufacturing process for producing 2,3,3,3-tetrafluoropropene (HFO-1234yf).

In particular, the hydrogen fluoride (HF) product is combined and reacted with 1,1,2,3-tetrachloropropene (HCO-1230xa) in a vapor phase reactor to produce 2-chloro-3,3,3-trifluoropropene (HCFO-1233xf).

In addition to the above and/or separately, the hydrogen fluoride (HF) product of Example 4 is combined and reacted with 2-chloro-3,3,3-trifluoropropene (HCFO-1233xf) in a liquid phase reactor to produce 2-chloro-1,1,1,2-tetrafluoropropane (HCFC-244bb).

Then, the 2-chloro-1, 1,1,2-tetrafluoropropane (HCFC-244bb) is conveyed into a reactor including a heated catalytic surface at a surface temperature of about 850° C. The composition is placed in contact with the heater surface for a contact time of about 10 seconds to dehydrochlorinate a portion of the 2-chloro-1,1,1,2-tetrafluoropropane (HCFC-244bb) to make 2,3,3,3-tetrafluoropropene (HFO-1234yf). The catalytic surface includes electroless nickel, nickel, stainless, steel, nickel-copper alloy, nickel-chromium-iron alloy, nickel-chromium alloy, nickel-chromium-molybdenum, or combinations thereof. The foregoing reaction may also be non-catalytic, i.e., thermally driven. Following the reaction, the contents of the reactor are conveyed into a distillation column and 2,3,3,3-tetrafluoropropene (HFO-1234yf) is separated from at least a portion of the unreacted 2-chloro-1,1,1,2-tetrafluoropropane (HCFC-244bb). The separated 2-chloro-1,1,1,2-tetrafluoropropane (HCFC-244bb) is recycled into the reactor and the pure 2,3,3,3-tetrafluoropropene (HFO-1234yf) is recovered.

### Example 6: Production of Trans-1-Chloro-3,3,3-Trifluoropropene (HFO-1233zd (E))

The hydrogen fluoride (HF) product of Example 4 is conveyed to a manufacturing process for producing trans-1-chloro-3,3,3-trifluoropropene (HFO-1233zd (E)). In this process, the hydrogen fluoride is mixed with 1,1,1,3,3-pentachloropropene (HCC-240fa) at elevated temperature and pressure to produce the desired 1-chloro-3,3,3-trifluoropropene (HCFO-1233zd) in a mixture of E- and Z-isomers.

The reactor products are separated to recover and recycle excess hydrogen fluoride (HF) and to remove and recover the hydrogen chloride (HCl). The remaining mixture comprises E- and Z-isomers of 1-chloro-3,3,3-trifluoropropene (HCFO-1233zd); high-boiling fluorinated components; low boiling impurities such as 1,1,1,3,3-pentafluoropropane (HFC-245fa), trifluoropropyne, and E- and Z-isomers of 1,3,3,3-tetrafluoropropene (HFO-1234ze), among others; and a small amount of residual HF. This mixture may be subjected to a distillation to remove the high-boiling fluorinated components from the 1-chloro-3,3,3-trifluoropropene (HCFO-1233zd), low boiling impurities, and HF.

### ASPECTS

Aspect 1 is a method of recovering hydrogen fluoride (HF) in a fluorocarbon production process, comprising: absorbing hydrogen fluoride (HF) from an organic stream into water in an absorption column to form a first solution of hydrogen fluoride (HF) and water having greater than about 35 wt. % HF; conveying at least a portion of the first solution of hydrogen fluoride (HF) and water to a distillation column; and distilling the first solution of hydrogen fluoride (HF) and water to provide a first distillate comprising at least about 95 wt. % hydrogen fluoride (HF) and a first bottoms stream comprising a second solution of hydrogen fluoride (HF) and water having greater than about 35 wt. % HF.
Aspect 2 is the method of Aspect 1, wherein the organic stream comprises at least 20 wt. % of trans-1,3,3,3-tetrafluoropropene (HFO-1234ze (E)).
Aspect 3 is the method of Aspect 1 or Aspect 2, further comprising conveying at least a portion of the first bottoms stream comprising a second solution of hydrogen fluoride (HF) and water having greater than about 35 wt. % hydrogen fluoride (HF) back to the absorption column.
Aspect 4 is the method of any of Aspects 1-3, further comprising conveying at least a portion of the first solution of hydrogen fluoride (HF) and water back to the absorption column.
Aspect 5 is the method of Aspect 4, further comprising cooling the portion of the first solution of hydrogen fluoride (HF) and water prior to conveying at least a portion of the first solution of hydrogen fluoride (HF) and water back to the absorption column.
Aspect 6 is the method of any of Aspects 1-5, further comprising recovering from the absorption column an organic stream having less than about 5 wt. % HF.
Aspect 7 is the method of any of Aspects 1-6, further comprising purifying the distillate comprising at least about 95 wt. % hydrogen fluoride (HF) to recover an anhydrous hydrogen fluoride (HF) product including less than about 1000 ppm of water.
Aspect 8 is the method of Aspect 7, further comprising conveying the anhydrous hydrogen fluoride (HF) product as a reactant to an additional fluorocarbon or chlorofluorocarbon production process.
Aspect 9 is the method of any one of Aspects 1 to 8, wherein the first distillate comprising at least about 95 wt. % hydrogen fluoride (HF) is conveyed to a process for manufacturing 2,3,3,3-tetrafluoropropene (HFO-1234yf).
Aspect 10 is the method of Aspect 9, wherein the first distillate comprising at least about 95 wt. % hydrogen fluoride (HF) is combined and reacted with at least one of: 1,1,2,3-tetrachloropropene (HCO-1230xa); and 2-chloro-3,3,3-trifluoropropene (HCFO-1233xf).
Aspect 11 is the method of any one of Aspects 1 to 8, wherein the first distillate comprising at least about 95 wt. % hydrogen fluoride (HF) is conveyed to a process for manufacturing trans-1-chloro-3,3,3-trifluoropropene (HFO-1233zd (E)).
Aspect 12 is the method of Aspect 11, wherein the process for manufacturing trans-1-chloro-3,3,3-trifluoropropene (HFO-1233zd (E)) comprises reacting the first distillate comprising at least about 95 wt. % hydrogen fluoride (HF) with 1,1,1,3,3-pentachloropropene (HCC-240fa).
Aspect 13 is a method of recovering hydrogen fluoride (HF) in a fluorocarbon production process, comprising: absorbing hydrogen fluoride (HF) from an organic stream into water in an absorption column to form a first solution of hydrogen fluoride (HF) and water having greater than about 35 wt. % HF; conveying at least a portion of the first solution of hydrogen fluoride (HF) and water to a distillation column; distilling the first solution of hydrogen fluoride (HF) and water to provide a first distillate comprising at least about 70 wt. % hydrogen fluoride (HF) and a first bottoms stream comprising a second solution of hydrogen fluoride (HF) and water having greater than about 35 wt. % HF; and distilling the first distillate to provide a second distillate comprising at least about 95 wt. % hydrogen fluoride (HF) and a second bottoms stream.
Aspect 14 is the method of Aspect 13, wherein the organic stream comprises at least 20 wt. % of HFO-1234ze (E).
Aspect 15 is the method of Aspect 13 or Aspect 14, further comprising conveying the second bottoms stream to the first distillation step.
Aspect 16 is the method of Aspect 14, further comprising cooling the second bottoms stream prior to conveying the second bottoms stream to the first distillation step.
Aspect 17 is the method of any one of Aspects 13 to 16, wherein the first distillate comprising at least about 95 wt. % hydrogen fluoride (HF) is conveyed to a process for manufacturing 2,3,3,3-tetrafluoropropene (HFO-1234yf).
Aspect 18 is the method of Aspect 17, wherein the first distillate comprising at least about 95 wt. % hydrogen fluoride (HF) is combined and reacted with at least one of: 1,1,2,3-tetrachloropropene (HCO-1230xa); and 2-chloro-3,3,3-trifluoropropene (HCFO-1233xf).
Aspect 19 is the method of any one of Aspects 13 to 16, wherein the first distillate comprising at least about 95 wt. % hydrogen fluoride (HF) is conveyed to a process for manufacturing trans-1-chloro-3,3,3-trifluoropropene (HFO-1233zd (E)).
Aspect 20 is the method of Aspect 19, wherein the process for manufacturing trans-1-chloro-3,3,3-trifluoropropene (HFO-1233zd (E)) comprises reacting first distillate comprising at least about 95 wt. % hydrogen fluoride (HF) with 1,1,1,3,3-pentachloropropene (HCC-240fa).
Aspect 21 is a hydrogen fluoride composition, comprising: at least 95 wt. % hydrogen fluoride; from 0.0001 wt. % to 0.8 wt. % 1,1,1,3,3-pentafluoropropane (HFC-245fa); from 0.0001 wt. % to 0.2 wt. % cis-1,3,3,3-tetrafluoropropene (HFO-1234ze (Z)); from 0.0001 wt. % to 0.1 wt. % trans-1,3,3,3-tetrafluoropropene (HFO-1234ze (E)); from 0.0001 wt. % to 0.01 wt. % trans-1-chloro-3,3,3-trifluoropropene (HFO-1233zd (E)); and less than 0.06 wt. % other organic products.

1. A method of recovering hydrogen fluoride (HF) in a fluorocarbon production process, comprising:
absorbing hydrogen fluoride (HF) from an organic stream into water in an absorption column to form a first solution of hydrogen fluoride (HF) and water having greater than about 35 wt. % HF;
conveying at least a portion of the first solution of hydrogen fluoride (HF) and water to a distillation column; and
distilling the first solution of hydrogen fluoride (HF) and water to provide a first distillate comprising at least about 95 wt. % hydrogen fluoride (HF) and a first bottoms stream comprising a second solution of hydrogen fluoride (HF) and water having greater than about 35 wt. % HF.

2. The method of claim 1, wherein the organic stream comprises at least 20 wt. % of trans-1,3,3,3-tetrafluoropropene (HFO-1234ze (E)).

3. The method of claim 1, further comprising conveying at least a portion of the first bottoms stream comprising a second solution of hydrogen fluoride (HF) and water having greater than about 35 wt. % hydrogen fluoride (HF) back to the absorption column.

4. The method of claim 1, further comprising conveying at least a portion of the first solution of hydrogen fluoride (HF) and water back to the absorption column.

5. The method of claim 4, further comprising cooling the portion of the first solution of hydrogen fluoride (HF) and water prior to conveying at least a portion of the first solution of hydrogen fluoride (HF) and water back to the absorption column.

6. The method of claim 1, further comprising recovering from the absorption column an organic stream having less than about 5 wt. % HF.

7. The method of claim 1, further comprising purifying the distillate comprising at least about 95 wt. % hydrogen fluoride (HF) to recover an anhydrous hydrogen fluoride (HF) product including less than about 1000 ppm of water.

8. The method of claim 7, further comprising conveying the anhydrous hydrogen fluoride (HF) product as a reactant to an additional fluorocarbon or chlorofluorocarbon production process.

9. The method of claim 1, wherein the first distillate comprising at least about 95 wt. % hydrogen fluoride (HF) is conveyed to a process for manufacturing 2,3,3,3-tetrafluoropropene (HFO-1234yf).

10. The method of claim 9, wherein the first distillate comprising at least about 95 wt. % hydrogen fluoride (HF) is combined and reacted with at least one of:
1,1,2,3-tetrachloropropene (HCO-1230xa); and
2-chloro-3,3,3-trifluoropropene (HCFO-1233xf).

11. The method of claim 1, wherein the first distillate comprising at least about 95 wt. % hydrogen fluoride (HF) is conveyed to a process for manufacturing trans-1-chloro-3,3,3-trifluoropropene (HFO-1233zd (E)).

12. The method of claim 11, wherein the process for manufacturing trans-1-chloro-3,3,3-trifluoropropene (HFO-1233zd (E)) comprises reacting the first distillate comprising at least about 95 wt. % hydrogen fluoride (HF) with 1,1,1,3,3-pentachloropropene (HCC-240fa).

13. A method of recovering hydrogen fluoride (HF) in a fluorocarbon production process, comprising:
absorbing hydrogen fluoride (HF) from an organic stream into water in an absorption column to form a first solution of hydrogen fluoride (HF) and water having greater than about 35 wt. % HF;
conveying at least a portion of the first solution of hydrogen fluoride (HF) and water to a distillation column;
distilling the first solution of hydrogen fluoride (HF) and water to provide a first distillate comprising at least about 70 wt. % hydrogen fluoride (HF) and a first bottoms stream comprising a second solution of hydrogen fluoride (HF) and water having greater than about 35 wt. % HF; and
distilling the first distillate to provide a second distillate comprising at least about 95 wt. % hydrogen fluoride (HF) and a second bottoms stream.

14. The method of claim 13, wherein the organic stream comprises at least 20 wt. % of HFO-1234ze (E).

15. The method of claim 13, further comprising conveying the second bottoms stream to the first distillation step.

16. The method of claim 14, further comprising cooling the second bottoms stream prior to conveying the second bottoms stream to the first distillation step.

17. The method of claim 13, wherein the first distillate comprising at least about 95 wt. % hydrogen fluoride (HF) is conveyed to a process for manufacturing 2,3,3,3-tetrafluoropropene (HFO-1234yf).

18. The method of claim 17, wherein the first distillate comprising at least about 95 wt. % hydrogen fluoride (HF) is combined and reacted with at least one of:
1,1,2,3-tetrachloropropene (HCO-1230xa); and
2-chloro-3,3,3-trifluoropropene (HCFO-1233xf).

19. The method of claim 13, wherein the first distillate comprising at least about 95 wt. % hydrogen fluoride (HF) is conveyed to a process for manufacturing trans-1-chloro-3,3,3-trifluoropropene (HFO-1233zd (E)).

20. A hydrogen fluoride composition, comprising:
at least 95 wt. % hydrogen fluoride;
from 0.0001 wt. % to 0.8 wt. % 1,1,1,3,3-pentafluoropropane (HFC-245fa);
from 0.0001 wt. % to 0.2 wt. % cis-1,3,3,3-tetrafluoropropene (HFO-1234ze (Z));
from 0.0001 wt. % to 0.1 wt. % trans-1,3,3,3-tetrafluoropropene (HFO-1234ze (E));
from 0.0001 wt. % to 0.01 wt. % trans-1-chloro-3,3,3-trifluoropropene (HFO-1233zd (E)); and
less than 0.06 wt. % other organic products.
